(19) United States
(12) Patent Application Publication
(10) Pub. No.: US 2008/0271344 A1
(43) Pub. Date: Nov. 6, 2008

(54) Goat Skin for Shoe and Apparel Manufacture

(76) Inventor: Simon Jeremy Skirrow, Queensland (AU)

Correspondence Address: YOUNG & THOMPSON, 209 Madison Street, Suite 500, ALEXANDRIA, VA, 22314, US

(21) Appl. No.: 11/816,657

(22) PCT Filed: Feb. 17, 2006
(86) PCT No.: PCT/AU2006/000226

§ 371 Date: Jul. 3, 2008

(30) Foreign Application Priority Data
Feb. 18, 2005 (AU) 2005900751

(51) Int. Cl. A43B 5/00; F16J 15/00

(52) U.S. Cl. 36/114; 69/21

(57) ABSTRACT

The present invention relates to the modification of goat and caprine leathers to render them suitable for use in the manufacture of sports shoes, and certain other items of footwear and apparel. Goatskin, while possessing some desirable properties, has poor wear and tear resistance. The present invention discusses the attachment of specific types of bonding layers to the non-grain face side to alter the overall performance of caprine leathers so that they may be used in durable footwear. Treatments to, and coatings on, the caprine leather are also discussed.

### FIELD OF INVENTION

The present invention is directed to methods for improving the performance of goat leathers for suitability in applications such as shoe and apparel manufacture, and particularly sports shoes.

### BACKGROUND DESCRIPTION

The present invention resulted from investigations into improving the performance of sports shoes, and particularly shoes for ball sports such as soccer. It should be envisaged that while the present invention has such applications in mind, the present invention will also lend itself to other applications such as gloves, other types of shoes and boots, and—in its broadest sense—to protective leathers, etc.

A number of considerations come into play when manufacturing a sports shoe such as a soccer boot, and particularly a ‘performance’ soccer boot. Among the user's desired characteristics are good grip, but also durability and abrasion resistance. The manufacturer is typically looking for a material that not only provides these properties, but is also easy to work with, can be used with traditional machinery and manufacturing techniques, and is also cost effective. The result is often a compromise between the different desirables of those involved. From a performance perspective, there should also be a reasonable level of flexibility, which can affect the ‘feel’ and response of the boot—important qualities for experienced players. However there should also be a reasonable level of tensile strength for the leather to be durable enough for sports shoe manufacture. Hence increasing tensile properties and durability, without overly sacrificing flexibility, are important aspects of modifying certain leathers for use in sports shoes.

Traditional soccer boots (and the like) have been manufactured from bovine leather. This leather has always been readily available, and is the ‘traditional’ material upon which the tanning industry has been founded. In shoe manufacture it is often a useful reference point for natural materials. Bovine leather is relatively hard wearing, for reasons described below, but does not exhibit the highest abrasion resistance. It is not necessarily the strongest leather, in regards of thickness, but is in plentiful supply. Neither does it necessarily exhibit the best grip characteristics either—i.e. the coefficient of friction between the boot leather and, say, a soccer ball. As a consequence the art has attempted to improve upon standard bovine leather, with varying degrees of success.

The art has developed and used synthetic materials exhibiting a wide range of physical properties. However, there is a significant market resistance to sports shoes of synthetic materials, particularly at the higher price and performance end of the market. As a consequence, synthetic uppers are virtually absent in this higher end of the market. This has forced the continued use of natural leathers, and predominantly bovine leather.

In the last few decades some exotic approaches have been tried. For instance, the use of shark skin has been proposed in at least GB1223066, a material exhibiting high abrasion resistance and grip. However this has not featured in the market, likely (it is thought) by a resistance of the market to alternatives to ‘leathers’, and by this meaning leathers which resemble bovine leather.

A newer leather which has gained increased acceptance and popularity is kangaroo leather. This leather exhibits better abrasion resistance than bovine leather, and is as strong (if not stronger) while being a thinner leather. This has made kangaroo a relatively premium leather, though faces a limited supply. It is envisaged that kangaroo leather sports boots will eventually be restricted to the upper end of the market.

Another leather, and which is readily available, is caprine (goat) leather. While this is readily available, it is considered unsuitable for athletic shoe manufacture for a number of reasons. While recent trials in the UK experimented with the use of goat leather for a sports shoe, the product never made it to market. To the applicant this reinforces the understanding of the industry that the qualities of goat leather make it unsuitable for shoe upper manufacture, and particularly for sports shoes. The reasons for this will now be discussed.

With reference to FIG. 1, most natural mammalian leathers comprise an upper grain layer, and a lower corium layer. We can also be more specific and identify a corium/grain junction whose properties can also differ from the other two layers. The properties of all three layers affect the performance of the resulting leather. Here there is shown, for comparison purposes, a typical hide for a goat (150) and a kangaroo (152). Absent in the kangaroo hide (152) is the typical backbone region (151) of quadrupeds.

The figures also show the differing thicknesses and ratios between the grain layer (153) and corium layer (154) for caprine leathers, and the grain (155) and corium (156) layers for kangaroo leathers. These will be referenced in the ensuing description.

The majority of the strength comes from the corium, where the fibre bundles from which it is made are more dense. The grain:corium thickness ratios will have a bearing on strength, with some typical examples being: bovine 25%:75% (% grain:% corium thicknesses), goatskin 45%:55%, and kangaroo 10%:90%. However these ratios do not tell the whole story. For instance, in thicker leathers such as bovine and caprine, the corium layer is shaved to reduce the overall thickness of the leather. This further reduces the relative and absolute thickness of the corium layer in these leathers. Additionally, for caprine leather, the grain layer is of uneven thickness. The result, as shown in FIG. 1, are regions with very thin corium layers. The resulting strength of such leathers, as would be used in shoe manufacture, is quite low. The result would be a shoe having a very short lifetime.

Yet further, the angle of weave of the fibres which make up the leather have a significant bearing on strength and durability. In kangaroo leather, for instance, the fibres are relatively well aligned and are almost parallel to each other and to the surface. The fibres, which are very long threadlike molecules of proteinaceous collagen twisted together, possess what is coined a ‘very low angle of weave’, and typically <30°. In contrast, the angle of weave typical for caprine leather is 45-60°, and bovine leather is >60°. In these leathers with higher weave angles, the fibres are more easily torn apart from each other, and is one of the reasons for the higher relative strength of kangaroo leather.

While bovine leather exhibits problems due to its high angle of weave, its low relative grain thickness compared to the corium at least partially compensates for this, making it useful for shoe manufacture. Unfortunately, caprine leather provides no such compensation and remains widely recognised as unsuitable for athletic shoe manufacture, except as a lining material.

Another factor influencing the physical properties of leather is the fat content. Fat inserts itself, in the living animal, within the fibre structure. During the tanning process the fat is removed, and we are left with voids in the leather's fibre structure which reduce strength per unit thickness. In kangaroo leather the fat content before tanning treatments is virtually negligible, while goat leather is typically 5-8%, and bovine leather 8-15%. This fat presence further reduces the strength and suitability for caprine leather for use in a variety of applications. Tests by the applicant on goat leather of 0.8-1.0 mm using a standard test method DIN 53329A, have yielded a tearing force of less than 20 N. This is not strong enough for soccer boot construction. In comparison, kangaroo leather has typically treble this tearing strength at a thickness of 0.8 mm.

A problem affecting the leathers of quadrupeds is the different nature of the leather and skin along the backbone (151). In this region the grain:corium thickness ratios are higher. When a skin is shaved to be a constant thickness, the problems of high grain:corium thickness ratios are exacerbated. This is particularly so for caprine leathers, where the ratio is a significant problem in other less ‘problematic’ areas of the hide. Thin corium layers, regardless of the type of leather, do not benefit effectively from the tanning process and have different physical and perceivable properties from leather from elsewhere on a hide.

Even for leathers other than caprine leather, the backbone region of the hide may be eliminated from use in the manufacture of the upper, unless this region is not shaved to the same thickness as the rest of the hide (i.e. it is thicker). However, this can reduce the usefulness of this part of the hide due to its increased thickness. Hence, problems still affect other traditional leathers which can render parts of hides unsuitable for shoe upper manufacture.

Another issue affecting most leathers in shoes is sweat resistance. A major tanning agent in athletic footwear is trivalent chrome, which provides good stability to the leather against heat, shrinkage, and providing a good cationic charge for high chemical exhaustion, strength, and softness. However, one weakness of the chrome crosslinking of the triple helix proteins of collagen is that it can be cleaved by the action of the lactic acid contained in perspiration. The result is an effective detanning of the leather, and the typical outcome is leather which is hard, cracked, and has often shrunk to half its original size. The effect is more prevalent and faster acting on thinner leathers. This can affect all types of leather though would have a particularly adverse effect on already compromised ‘normal’ caprine leather.

Despite the problems associated with caprine leather, the relatively thick grain structure of the leather does offer good abrasion resistance—being substantially higher than bovine or kangaroo leather. This has prompted the recent unsuccessful investigations in the UK into the use of goat leather. However, while shoes made from goat leather may exhibit good abrasion resistance, they offer little strength or durability. Hence, while goat leather exhibits at least one very desirable physical characteristic, other problems associated with caprine leather has prevented its use.

Caprine leather can also be relatively flexible and has properties which offer good subjective qualities such as feel. However, the aforesaid problems have limited the use of caprine leather in articles such as sports shoes and equipment.

One piece of prior art, EP0362684, discloses a method for reinforcing goat leather to make it suitable for other uses. The technique relies on a plastic surface coating, which is typically a hot-melt process, to toughen the leather substantially—making the leather penetration resistant as well as resistant to cuts and scratches. However such processes make the leather unsuitable for sports shoes as the resulting leather would lack the flexibility desirable in a good sports shoe. Additionally, any such surface coatings would reduce the grip (i.e. the co-efficient of friction between a contacting ball and shoe), which is undesirable in sports shoes—particularly those used for ball sports such as soccer or rugby, etc. Additionally, most leather processing plants are not normally equipped for applying hot melt plastics such as disclosed in EP0362684, and thus there is some commercial desirability in using manufacturing techniques amenable to standard available equipment.

It is therefore one object of the present invention to address at least one or more of the aforementioned considerations.

It is a object of the present invention to a method for modifying or processing caprine leather to render it suitable for use in shoe manufacture, and particularly sports shoes.

Preferably it is also an object to provide a sports shoe having an upper at least partially formed from a caprine leather so treated or processed.

At the very least it is an object of the present invention to provide the public with a useful alternative choice.

Aspects of the present invention will be described by way of example only and with reference to the ensuing description.

### GENERAL DESCRIPTION OF THE INVENTION

According to one aspect of the present invention there is provided a method for modifying leather comprising the application of at least one bonded layer to the rear of the leather.

According to another aspect of the present invention there is provided a method, substantially as described above, in which the leather is caprine leather.

According to another aspect of the present invention there is provided a method, substantially as described above, in which the layer is stretch resistant.

According to another aspect of the present invention there is provided a method, substantially as described above, in which the layer is cut resistant.

According to another aspect of the present invention there is provided a method, substantially as described above, in which the layer exhibits an improved tensile strength, relative to the unprocessed caprine leather, in at least one direction.

According to another aspect of the present invention there is provided a method, substantially as described above, in which the layer exhibits an improved tensile strength, relative to the unprocessed caprine leather, in at least two non-parallel directions.

According to another aspect of the present invention there is provided a method, substantially as described above, in which the bonded layer comprises at least one layer of a fabric.

According to another aspect of the present invention there is provided a method, substantially as described above, in which the fabric is a woven fabric.

According to another aspect of the present invention there is provided a method, substantially as described above, in which the fabric comprises one or more fabrics from the group comprising: canvas, Cordura®, woven Kevlar® or its substitutes.

According to another aspect of the present invention there is provided a method, substantially as described above, in which the bonded layer includes one or more reinforcing materials selected from the group comprising: Kevlar® filaments or its substitutes, braided monofilaments, ceramic fibres, synthetic meshes, mats comprised of non-woven fibres.

According to another aspect of the present invention there is provided a method, substantially as described above, in which the bonded layer comprises a layer of a resin or thermoplastic material.

According to another aspect of the present invention there is provided a method, substantially as described above, in which the resin or thermoplastic material impregnates into at least part of the fibre structure of the corium of the leather.

According to another aspect of the present invention there is provided a method, substantially as described above, in which the resin or thermoplastic material includes a reinforcing material, substantially as described above.

According to another aspect of the present invention there is provided a method, substantially as described above, in which the resin or thermoplastic material includes a layer of fabric.

According to another aspect of the present invention there is provided a method, substantially as described above, in which the resin or thermoplastic material is the bonding material for the material of the bonded layer.

According to another aspect of the present invention there is provided a method, substantially as described above, in which there is included within the bonded layer at least one of: phase change materials, anti-microbials, super absorbers to remove sweat, water resistant agents, and moisture management agents.

According to another aspect of the present invention there is provided a method, substantially as described above, in which the resin or thermoplastic material is selected from a group comprising: acrylics, urethanes, plastisols, butadienes, latex, rubber (natural and/or synthetic), polyester, neoprene (polychloroprene), silicones, and cyanoacrylates.

According to another aspect of the present invention there is provided a method, substantially as described above, in which a urethane resin, loaded onto the leather at 20±10 g/sqft is used.

According to another aspect of the present invention there is provided a method, substantially as described above, in which the modified leather is reinforced with an aramid fibre, such as Kevlar®, in a bonded layer.

According to another aspect of the present invention there is provided a method, substantially as described above, in which the modified leather has been fat-liquored.

According to another aspect of the present invention there is provided a method, substantially as described above, in which the modified leather has been fat-liquored to the extent that the stretchability of the leather layer has been increased.

According to another aspect of the present invention there is provided a method, substantially as described above, in which the grain face of the leather has been flattened by mechanical processing.

According to another aspect of the present invention there is provided a method, substantially as described above, in which the mechanical process is rotary ironing, optionally embossing with a finer grain print.

According to another aspect of the present invention there is provided a method, substantially as described above, in which the leather has only been minimally bated, or not bated at all.

According to another aspect of the present invention there is provided a method, substantially as described above, in which the leather has been subjected to a staking process.

According to another aspect of the present invention there is provided a method, substantially as described above, in which the grain face of the modified leather includes a coating.

According to another aspect of the present invention there is provided a method, substantially as described above, in which the grain face coating comprises a with at least one of: a flex resistant coating, a rub fastness improving coating, an abrasion resistant coating, a urethane or polyurethane resin, an acrylic resin, a hybrid acrylic-urethane resins, crosslinked urethane or acrylic resins, cross-linked urethane/acrylic resins, and a water resistant coating.

According to another aspect of the present invention there is provided a method, substantially as described above, in which the leather has been treated to exhibit water repellence or resistance.

According to another aspect of the present invention there is provided a method, substantially as described above, in which at least part of the upper has been coated with A PIB polymer selected from the following group: polyisobutylene (also known as butyl rubber, 2-methyl-1-propene homopolymer, isobutylene polymer, polymerized 2-methylpropene, isobutylene resin, and has the molecular formula: [C₄H₈]ₙ), and polyisobutylene-isoprene copolymers.

According to a further aspect of the present invention there is provided a modified leather for use in shoe or apparel manufacturer comprising a tanned leather having at least one bonded layer on its non-grain side.

According to another aspect of the present invention there is provided a modified leather, substantially as described above, in which the leather is a caprine leather.

According to another aspect of the present invention there is provided a modified leather, substantially as described above, in which the bonded layer improves the tear strength of the leather to in excess of 30 N for a 0.8 mm thick leather, or proportionately relative thereto for greater thicknesses, using standard test method DIN 53329A.

According to another aspect of the present invention there is provided a modified leather, substantially as described above, in which the bonded layer improves the tear strength of the leather to in excess of 40 N for a 0.8 mm thick leather, or proportionately relative thereto for greater thicknesses, using standard test method DIN 53329A.

According to another aspect of the present invention there is provided a modified leather, substantially as described above, in which the tensile strength of the modified leather is improved by at least 50% in at least one direction as opposed to the unmodified leather.

According to another aspect of the present invention there is provided a modified leather, substantially as described above, in which the tensile strength of the modified leather is improved by at least 50% in at least two non-parallel directions as opposed to the unmodified leather.

According to another aspect of the present invention there is provided a modified leather, substantially as described above, in which the modified leather has a reinforcing material such as a woven fabric, mesh, or non-woven mat present in a bonded layer.

According to another aspect of the present invention there is provided a modified leather, substantially as described above, in which the modified leather has a reinforcing material such as one or more mono-filaments, elemental fibres, braids, or ribbons present in a bonded layer.

According to another aspect of the present invention there is provided a modified leather, substantially as described above, in which the bonded layer includes a discrete layer bonded to the non-grain side of the leather.

According to another aspect of the present invention there is provided a modified leather, substantially as described above, in which the discrete layer is a kangaroo or bovine leather comprising, in at least, part of the corium thereof.

According to another aspect of the present invention there is provided a modified leather, substantially as described above, in which the bonded layer comprises a resin or thermoplastic material which coats and bonds to the non-grain side of the leather.

According to another aspect of the present invention there is provided a modified leather, substantially as described above, in which the resin or thermoplastic material includes, or has impregnated within it, a reinforcing material substantially as described above.

According to another aspect of the present invention there is provided a modified leather, substantially as described above, in which a urethane resin, acrylic resin, hybrid urethane/acrylic resin, or cross-linked variations of the foregoing resins, is used.

According to another aspect of the present invention there is provided a modified leather, substantially as described above, in which a urethane resin, loaded onto the leather at 20±10 g/sqft is used.

According to another aspect of the present invention there is provided a modified leather, substantially as described above, in which the modified leather is reinforced with Kevlar® in a bonded layer.

According to another aspect of the present invention there is provided a modified leather, substantially as described above, in which the modified leather has been fat-liquored.

According to another aspect of the present invention there is provided a modified leather, substantially as described above, in which the modified leather has been fat-liquored to the extent that the stretchability of the leather layer has been increased.

According to another aspect of the present invention there is provided a modified leather, substantially as described above, in which the grain face of the leather has been flattened by mechanical processing.

According to another aspect of the present invention there is provided a modified leather, substantially as described above, in which the mechanical process is rotary ironing, optionally embossing with a finer grain print.

According to another aspect of the present invention there is provided a modified leather, substantially as described above, in which the leather has not been bated, or only minimally bated.

According to another aspect of the present invention there is provided a modified leather, substantially as described above, in which the leather has been subjected to a staking process.

According to another aspect of the present invention there is provided a modified leather, substantially as described above, in which the grain face of the modified leather includes a coating.

According to another aspect of the present invention there is provided a modified leather, substantially as described above, in which the grain face coating comprises a with at least one of: a flex resistant coating, a rub fastness improving coating, an abrasion resistant coating, a urethane or polyurethane resin, a water resistant coating.

According to another aspect of the present invention there is provided a modified leather, substantially as described above, in which the leather has been treated to exhibit water repellence or resistance.

According to another aspect of the present invention there is provided a modified leather, substantially as described above, in which at least part of the upper has been coated with A PIB polymer selected from the following group: polyisobutylene (also known as butyl rubber, 2-methyl-1-propene homopolymer, isobutylene polymer, polymerized 2-methylpropene, isobutylene resin, and has the molecular formula: [C₄H₈]ₙ), and polyisobutylene-isoprene copolymers.

According to another aspect of the present invention there is provided a modified leather, substantially as described above, in which the leather has been treated with hydrophobic fats within the fibre structure.

According to a further aspect of the present invention there is provided a modified leather resulting from a process substantially as described above.

According to a further aspect of the present invention there is provided a sports shoe in which at least part of the upper has been manufactured from a modified leather, substantially as described above.

According to a another aspect of the present invention there is provided a sports shoe, substantially as described above, in which the modified leather is a modified caprine leather.

According to another aspect of the present invention there is provided a sports shoe, substantially as described above, in which at least part of the upper has been coated with A PIB polymer selected from the following group: polyisobutylene (also known as butyl rubber, 2-methyl-1-propene homopolymer, isobutylene polymer, polymerized 2-methylpropene, isobutylene resin, and has the molecular formula: [C₄H₈]ₙ), and polyisobutylene-isoprene copolymers.

According to another aspect of the present invention there is provided a sports shoe, substantially as described above, in which the sports shoe is a soccer boot.

According to a further aspect of the present invention there is provided an adhesive patch for application to a sports shoe or boot, the patch comprising an area of modified leather, substantially as described above, with a self-adhesive backing on the non-grain face thereof.

According to a further aspect of the present invention there is provided as adhesive patch, substantially as described above, in which the modified leather is a modified caprine leather.

A number of terms shall be defined for use within this specification.

“Caprine leather” shall refer to a leather derived from a goat or caprine animal.

“Bating” is an enzyme based treatment of leathers which causes controlled degradation of elastin fibres, and optionally also one or more of: removal of partially hydrolysed collagen, removal of globular proteins, and removal of hydrolysed keratin; for enhanced softness.

“Rub fastness” is a test to determine how much colour is transferred during rubbing in wet and dry conditions.

“Abrasion Resistance” refers to the resistance of the outer face of a leather to abrasion and is typically performed by a standard test such as the Taber test.

“Ballistic fibres” shall refer to fibres, typically synthetic, used in the construction of bullet proof vests and body armour. Examples include, but are not restricted to, Kevlar®, Zylon®, Magellan M5®, Twaron®, Spectra®, and Dyneema®.

The present invention has been developed with the specific problems of caprine leathers in mind, though may find other applications. In order for caprine leathers to be suitable for use as an outer on shoes, and in particular sports shoes such as soccer boots, modification of the caprine leather is necessary. Specific problems affecting other leathers, for instance problems with leathers derived from the backbone region of quadrupeds, and thus it is envisaged that the principles of the present invention may also be applied to other leathers to address various problems and issues.

The present invention comprises the addition of at least one bonded layer to the rear, non-grain face, of the leather to alter the overall physical properties. Optionally also, other treatments to the leather may be performed, including treatments prior to the bonding process and which may be best performed during the tanning process.

Typically the raw starting material for the addition of the bonded layer(s) is a tanned leather, and typically a caprine leather. This may be processed according to normal tanning processes, though preferably any bating processes are eliminated from the tanning, or only minimally performed to soften the leather to the degree required. Should it be desired to make the skin softer, then the use of fats and oils (e.g. fat liquoring processes) should be adopted. These techniques preserve the fibre structure of the leather, unlike bating which physically degrades the fibre structure. For leathers such as caprine leather, with an already compromised corium layer, techniques which degrade the strength or toughness imparted by the fibre structure are preferably avoided.

Treatments such as fat-liquoring may be performed on the tanned leather. Fat-liquoring, up to a certain point, may improve strength though excess fat-liquoring can create a leather which is too stretchy and resilient, and thus normally unsuitable for shoe uppers. While this would definitely be avoided as further weakening caprine leather, excess fat-liquoring is permissible for the present invention as the bonded rear layers address these normal issues of concern. Accordingly the present invention provides means for providing a usable leather product, which has the properties of excess fat-liquoring, but without those properties which otherwise prevent its use in shoe upper construction.

The tanned leather may also be shaved to the desired thickness. For caprine leather this is preferably to a thickness of around 0.9-1.1 mm inclusive, though for some embodiments the greater inclusive range of 0.7-1.5 mm may be acceptable. An important consideration is to not totally or substantially shave off the corium layer. Hence, the region of the hide from which the leather is derived will have a bearing on this, as well as the type of leather. Shaving techniques which manually or automatically adjust the shaving thickness, such as where the grain layer is thicker, may be employed.

The grain face may be subjected to mechanical processes, either prior to or subsequent to modified treatments, such as rotary ironing, embossing, etc to affect the apparent grain size. These may also include techniques such as where a durable design is cut into the surface of the leather, by various means such as laser etching, print and buff, etc. These techniques may be advantageous for some caprine leathers, particularly those exhibiting a larger grain (which is influenced largely be environmental factors, the age of the goat, etc.) A grain size which is too coarse can require a greater coating thickness to cover the peaks and valleys of the grain, should coatings be applied to the grain face of the leather. Flattening or reducing this grain size by such mechanical techniques can allow a thinner coating to be applied, addressing a further potential issue associated with caprine leathers. Excess coating thicknesses not only cost more during manufacture, but also affect physical properties such as breathability, flexing, etc.

Other processes may also be performed as part of tanning or prior to the bonding step(s). These may include staking processes which are typically mechanical processes which soften the leather and provide a fully integral structure in the grain layer. Preferred techniques include synchro-staking (such as the process from Cartigliano) and milling (which is a collective term for tumbling dry skins in a humid environment to get the fibre structure moving).

Tanning techniques should also adopt practices which allow good chemical penetration. Carprine leather, and other leathers with reduced corium layer thicknesses or structures) do not always accept tanning chemicals well. The use of dispersants which promote penetration of tanning and treatment chemicals into the fibre structure are preferred. The proper selection of treatment conditions, such as pH, temperature, time, particle and emulsion size (of chemicals and agents), to improve penetration into the fibre structure are desirable.

Various coatings affecting abrasion resistance, rub fastness, and flexing etc., may be applied to the outside grain face of the leather. These may be applied before or after the bonding process. Suitable primers may also employed to increase adhesion. This is more important on water resistant leathers. Such primers and coatings may be roller coated (or sprayed etc.) onto the grain face. Cross-linkers such as carbodiimides and isocyanates may be employed, particularly in primers. It is preferable that such coatings do not adversely affect desirable properties of the resulting leather, such as grip or ‘feel’, to any appreciable extent.

Flexing control may be achieved by high performance resins (available in the industry for this purpose) which exhibit a good and appropriate resistance to flexing, as well as good elongation characteristics. Rub fastness may be addressed by the use of clear topcoats, or urethane/acrylic resin coatings.

Abrasion resistance can be improved by the use of high performance resins, such as urethane or acrylic resins, designed for hardwearing applications (such as in the automotive industry). Abrasion resistance may be further enhanced by the incorporation of hard particulates of a micro- or nano-size. Ceramic spheres, such as used in the paint industry, is one preferred option. Again, the thickness and nature of such coatings should not be such as to affect desirable properties of the resulting leather, such as grip or ‘feel’, to any appreciable extent.

While the bonded layer attached to the non-grain face of the leather will typically address sweat migration and leather degradation, the option still exists to treat the leather portion to address sweat promoted degradation. Preferred options include the use of glutaraldehyde to promote secondary tanning, a suitable current product being Derugan 3080® from Schill & Seilacher. Another option is the use of acrylic lubricating polymers to protect the fibre structure. The impartation of water resistance to the fibre structure also provides protection against sweat promoted degradation.

Modifying the tanned leather to provided water resistant properties is an option. A wide range of techniques are known and may be implemented. While it is an option that some of these properties can be inferred by the bonded layer(s), there is often also advantage in conferring these properties to the outer leather layers of the final product—it is here that will be subjected to the greatest extremes in moisture.

Some preferred treatment methods for inferring water resistance include the use of hydrophobic fats to lubricate the fibre structure (the leather then being capped by rendering the emulsification tail inactive by the use of a cationic treatment). Acrylic lubricating polymers are known and are preferred in that they are resistant to washing processes, and also impart good tear and tensile strength properties to the leather. A suitable product is Lubritans® from Rohm & Haas in the USA.

A variety of processes exist for modifying leathers, which are then suitable for use for the application of bonded layers. While such options and processes may theoretically be ignored, their use provides for a superior rather than inferior product. Such inferior products may be unsuitable or undesirable for certain applications, such as uppers for performance sports shoes and boots. This is especially true in the case of caprine leathers and the problems which affect them. Some tanneries do provide what are classified as ‘technical goatskins (or leathers)” and which have been subjected to many of the aforesaid processes. Currently Pittards is one such tannery which provide goat leathers treated under their trade-marked WR100X® technology. This is a suitable caprine leather for use in the bonding processes of the remainder of the invention to be described.

A further consideration is, despite waterproofing modifications to the leather itself, most athletic shoes are assembled by stitching. Here the thread acts as a wick for moisture from the outside to the inside. Accordingly, preferred embodiments of a shoe according to the present invention (and this may be extended to apparel) include a suitable resin coating or seam sealing tape over the stitching, normally on the inside of the shoe. Suitable resins include (but are not restricted to) those suitable for use in a bonding layer. Seam tapes may include PTFE tapes, PVC tapes, PU tapes etc. A suitable source are those manufactured by West Bridgford Machine Company in Nottingham, United Kingdom.

The leather substrate is subjected, in the invention, to the addition of at least one bonded layer. Such a layer can vary in its nature and construction. In a simplest form the bonded layer may be a resin, and in some embodiments may comprise a thermoplastic substance, attached to the non-grain face of the leather. Ideally this impregnates into the fibre structure of the leather, increasing its adhesion thereto. This can also strengthen the fibre structure of the leather with which it interacts, potentially increasing the tearing and/or tensile strengths of the leather itself.

Care needs to be taken that the bonded layer(s) do not transform the leather in an undesirable way. Overly stiffening the leather can provide a very durable product, though not necessarily ideal for a sports shoe. Accordingly, in most embodiments, it is desirable that the choice of bonding materials, including resins/adhesives and reinforcing materials, retains desirable properties (such as a nominal degree of flexibility) while improving the durability of the leather to render it suitable for use in applications such as sports shoe construction, gloves, etc.

In a more sophisticated embodiment, the resin or resilient thermoplastic may be impregnated with one or more reinforcing material. In another set of embodiments, the resin or thermoplastic may bond a discrete layer to the leather, or may be substituted by an adhesive. This layer may be a fabric or other material altering the physical properties of the leather. Again the choice of reinforcing material should reflect the intended end use of the leather. Many fabrics and fibrous materials are particularly suitable as they possess a degree of flexibility or drapability enabling them to conform to bending or flexing of the leather during construction or use. Additionally, their open structure provides an ideal key for a resin or plastic binder.

Various resins or thermoplastic materials may be used. Ideally it is a material able to be applied in a fluid state, or at least converted to such a state to enable at least partial impregnation into the fibre structure of the leather. Preferred materials include various urethane and polyurethane resins. A variety of bonding materials may be employed, including: acrylics, urethanes, plastisols, butadienes, latex, rubber (natural and/or synthetic), polyester, neoprene (polychloroprene), silicones, and cyanoacrylates. This list is not intended to be limiting, and other substances may be used. Some of these require curing, and may be cured in a number of ways, such as time, heat, UV, radiation, etc. In addition many of the above resins may be further enhanced with cross-linkers, such as isocyanate, carbodiimide, aziridine, epoxy, and other functional types. This provides a range of possibilities to the user to tailor a particular product of the invention to their specific needs.

In preferred embodiments the resin types have a high tensile strength type of at least 6500 psi at break. This is then married with an elongation at break between 400 and 500%. A suitable material is Witcobond W281 Aqueous Polyurethane dispersion from Crompton Europe Ltd.

Ideally these materials should be flexible, though not so soft as not to improve the tearing or tensile strength of the leather (unless used in conjunction with other bonded layers), nor so firm as to make the leather too rigid for use in shoe or other manufacture. It is envisaged that some experimentation with resins may be required to optimise the particular leather (and its specific properties) to the desired end properties of the user, though is considered to be within the scope of a skilled worker given the description given herein.

Such resins and thermoplastics may be impregnated with reinforcing agents to alter the overall physical characteristics. Preferably improvements in tensile strength, and resistance to stretching are desired. This is preferably in at least one direction, more preferably in at least two-non parallel directions, and more preferably in at least two substantially perpendicular directions. The incorporation of non-elastic fibres, or materials made from these, as reinforcing materials can address these issues. A wide variety of materials may be considered though some preferred reinforcing materials include: metal filaments, braids, meshes, and fabrics; ceramic fibres, mats (non-woven), woven fabrics of ceramic fibres, braids of ceramic fibres; Kevlar® (and its equivalents) filaments, fabrics, meshes; Zylon® (a thermoplastic polyurethane) filaments, fabrics, meshes and sheets; Magellan M5® filaments, fabrics, or meshes; elemental (being of a single chemical element) filaments, fabrics and meshes of elemental filaments; fabrics of synthetic materials, mats of synthetic materials; ballistic fabrics.

In other embodiments a layer of material, such as a fabric, is bonded to the leather. Again these can include a range of types of adhesives or bonding agents, and in particular acrylic or urethane based resins are suitable. The Permuthane® (solvent based) or Permutex® (aqueous based) PU resins from Stahl of Holland are particularly suitable for this type of application. A good typical application would be RU9012 cross linked with isocyanate. In an example of its use, the operation of laminating will use heat and pressure to activate the adhesive fully. Two simple methods (by way of example) are:
i) to cut the leather and the laminate material in the same size at the shoe factory and then apply the adhesive (e.g. brush, roller, spray, etc) and sandwich the two pieces in a press at 60′ C or
ii) in a continuous phase at the tannery (but this does result in more wastage).

Hence the fabric may be bonded by a suitable compatible adhesive, though may also be bonded by a resin or thermoplastic material such as described above. Such intermediate bonding/adhesive layers may include reinforcing materials, such as also discussed above.

The material bonded to the leather is typically a discrete sheet material able to be bonded to the leather. It may comprise a woven or non-woven material or fabric. It typically comprises reasonable strength and durability properties, and will at least partially substitute properties lacking in the corium layer of the leather, particularly where the corium layer has been shaved. The material should also be resistant to moisture, and ideally not degraded by sweat. Materials such as Cordura® used in luggage manufacture and as a component of tough woven fabrics; fabrics incorporating ballistic fibres such a Kevlar®, certain aramids, Zylon®, Magellan M5® etc; resin impregnated woven fabrics such as polyurethane coated fabrics; sheets of tough flexible plastics; sheets of resins or plastics impregnated with reinforcing materials (such as described above); coated canvasses; can all be considered.

Also to be considered are layers of other leathers, typically including a portion of the corium layer of the chosen leather, and ideally a different type of leather than a caprine leather. However, given the variables in most leathers, and the high angle of weave (reducing strength) of fibres in leathers other than kangaroo, the preference of the present invention is for the use of synthetic materials whose properties are more consistent and defined.

The various layers or resins may be applied by standard industry techniques. For instance, urethane resins may be applied by roller coating, as may indeed many adhesives.

Additional processes may be applied (pre-, during, or post layer addition) to the grain face of the leather. The applicant has described in separate patent applications the use of surface coatings to improve dry and wet grip characteristics of shoe leathers. These coatings and treatments are the subject of patent applications AU 2004902848, AU 2004902849, and PCT applications derived therefrom. One specific treatment is a surface coating of a PIB polymer selected from the following group: polyisobutylene (also known as butyl rubber, 2-methyl-1-propene homopolymer, isobutylene polymer, polymerized 2-methylpropene, isobutylene resin, and has the molecular formula: [C₄H₈]ₙ), and polyisobutylene-isoprene copolymers.

As an indication of the relative abrasion resistance of common leathers and previously proposed shoe materials, compared to caprine leather, the following data is presented. The abrasion resistance characteristics of the following leathers were tested using a Taber Tester, H18 Wheels, 1 kg loading. The amount of cycles relates to the number of rotations in order to significantly damage the grain part of the leather fibre structure:

| | |
|---|---|
| Bovine (Cow) | 185 |
| Marsupial (Grey Kangaroo) | 350 |
| Caprine (Goat) | 750 |
| Snake (Python) | 850 |
| Fish (Stingray) | 1000+ |

As can be appreciated, the high relative abrasion resistance of caprine leather is advantageous if it is able to be utilised in shoe construction. The present invention, by addressing issues associated with goat leather for shoe construction, seeks to provide a novel product enabling the use of this readily available leather.

Accordingly the present invention also includes a sports shoe whose upper is made, at least in part, of a modified leather according to the present invention. Preferably this is a modified caprine leather. Such leathers, according to the present invention, may exist in a number of different forms depending on the specific embodiment. Sufficient flexibility in its processing exists for a number of modified leathers to be used, and ideally according to standard or traditional methods of sports shoe construction, or at least using existing equipment with little or no modification.

The sports shoe may have its entire upper formed of a modified leather according to the present invention, or at least part of the upper. It is possible that different parts of the upper may be constructed by different materials, be they different embodiments of modified leathers according to the present invention, or by ‘standard’ leathers. Various modified leathers of the present invention may also be considered for linings.

The sports shoes of the present invention may vary, though the preferred shoe (the focus of this description) is the soccer boot. However the present invention may be used on other types of sports shoes such as cross-trainers, hockey boots, rugby boots, climbing shoes and boots, walking and tramping boots, golf shoes etc. They may also be used for ‘non-sports’ shoes including casual shoes and sandals, dress shoes, safety shoes and boots, and specialised shoes or boots etc. The modified leather may also be used in the manufacture of gloves, jackets, and other apparel. Where ballistic fibres have been bonded into the structure, bullet resistant applications can be considered.

Another aspect of the present invention comprises a self-adhesive patch able to be attached to a shoe or boot. This may be able to be trimmed to size or shape, and may be used to increase the abrasion resistance (or other properties) of part of a shoe or boot, or act as a repair. Various self-adhesive backings are known and may be used, usually with an appropriate removable cover strip or layer.

Possible variations to the invention may include the inclusion of enhancing agents in the bonded layer. These may be incorporated into the bonding agent or resin etc. and may include, for example, at least one of: phase change materials, anti-microbials, super absorbers to remove sweat, water resistant agents, and moisture management agents.

In some specialised applications different types of fabrics may be bonded to the non-grain face of the caprine leather. For instance, elastane type fabrics—such as Lycra®—may be laminated to the rear of the caprine leather. These may find use in certain parts of the upper of a shoe, and may find use in the construction of gloves or other apparel.

As can be appreciated there are many variations to the present invention, and ways by which it may be implemented. Some specific embodiments will now be described, by way of example.

### DESCRIPTION OF DRAWINGS

FIG. 1a is a representation of a typical goat hide, used in a discussion of the prior art;

FIG. 1b is a representation of a typical kangaroo hide, used in a discussion of the prior art;

FIG. 1c is a cross-sectional view (not to scale) of unshaved goat leather, used in a discussion of the prior art;

FIG. 1d is a cross-sectional view (not to scale) of unshaved kangaroo leather, used in a discussion of the prior art;

FIG. 1e is a cross-sectional view (not to scale) of shaved goat leather, used in a discussion of the prior art;

FIG. 1f is a cross-sectional view (not to scale) of shaved kangaroo leather, used in a discussion of the prior art;

FIG. 2 are diagrammatic cross sectional views of some various embodiments of modified leather according to the present invention;

FIG. 3 is a diagrammatic perspective view of a shoe according to the present invention, and

FIG. 4 is a diagrammatic perspective view of a patch according to the present invention.

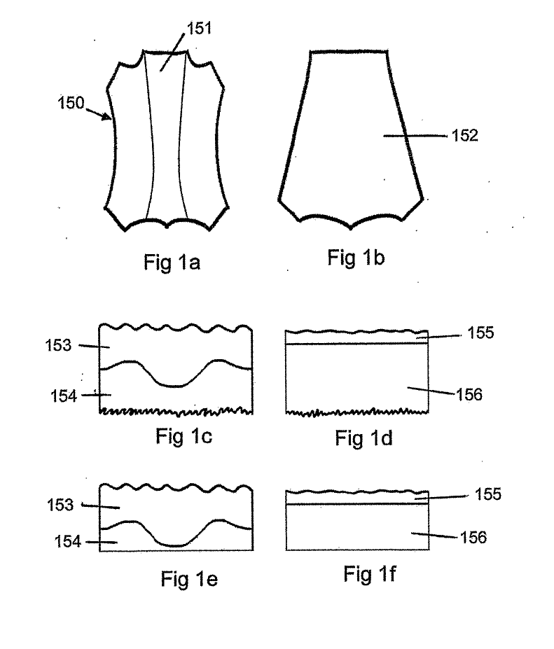

### BEST METHODS OF PERFORMING THE INVENTION

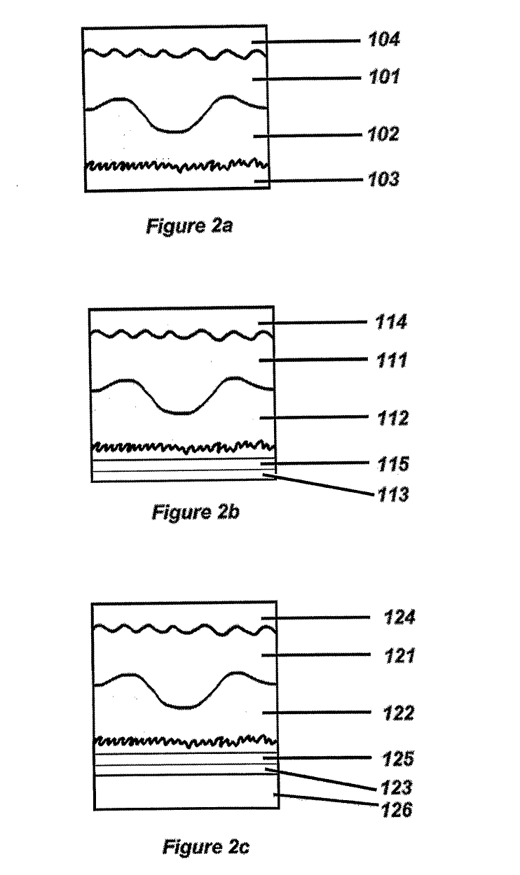

FIG. 2 illustrate some various embodiments possible within the scope of the present invention.

### Example 1

FIG. 2a illustrates a caprine leather with the grain face (101) and corium (102) layer visible. Ideally this is a shaved leather to about 1.0 mm thickness (other than back bone region) and tanned in a process including excess fat-liquoring and treated to include an acrylic lubricating polymer such as Lubritans by Rohm & Haas (USA).

The leather has been rotary ironed to reduce the natural grain size, and optionally embossed with a finer grain print.

To the rear has been applied a bonded resin layer (103) which is a urethane resin exhibiting a reasonable tensile strength. In this embodiment the resin types have a high tensile strength type of at least 6500 psi at break. This is then married with an elongation at break between 400 and 500%. A suitable material is Witcobond W281 Aqueous Polyurethane dispersion from Crompton Europe Ltd.

This is roller coated on to the non-grain face at a loading of 15-25 g/sqft (though 10-100 g/sqft can be considered depending on the specific application) and in a manner to ensure some penetration into the fibres of the corium layer 3.

A protective coating (104) is provided, which is a urethane material offering rub fastness and abrasion resistant properties.

### Example 2

FIG. 2b illustrates an alternative embodiment of the present invention. For the sake of simplicity we shall use as a basis (for this embodiment) the embodiment of FIG. 2a, with (111) representing the grain layer of the caprine leather, (112) the corium layer, (113) the bonded resin layer, and (114) the protective top coat. Where this embodiment differs is in the incorporation of a reinforcing material (115) into the resin layer (113). This is a woven fabric, laid over the non-grain face of the leather prior to roller-coating the resin. The fabric may be a woven fabric of synthetic fibres (with optional natural fibre content). The synthetic fibres may include: nylon, Kevlar®, Cordura®, Zylon®, Magellan M5®, ballistic fibres, and combinations thereof.

A different adhesive/resin may be substituted. This may comprise, for example, in parts by weight to a total of 100%:

| | |
|---|---|
| 75-85% | an aqueous urethane resin such as a Unires ® resin by Stahl |
| | of Europe; |
| 9-15% | an aqueous acrylic resin such as an RA resin by Stahl |
| | of Europe |
| 0-8% | a cross-linking agent |
| 0-0.1% | thickener |

The process for applying the fabric substrate may proceed as follows. The fabric is drawn from a roll and fed through rollers which apply a coating of the adhesive resin. The application rate is typically around 50±10 g/sq.metre. The leather hide is then introduced to the coated fabric substrate and pressed together between rollers. Ideally this occurs at around 60° C., and at a pressure of around 6 bar. The grain face of the leather may be overlaid with a temporary plastic film for protection. The laminated hides are then trimmed and laid on a rack to dry.

### Example 3

FIG. 2c illustrates a further embodiment of the present invention. For the sake of simplicity we shall use as a basis (for this embodiment) the embodiment of FIG. 2a, with (121) representing the grain layer of the caprine leather, (122) the corium layer, (123) the bonded resin layer, and (124) as an optional protective top coat.

Where this embodiment differs is in the bonding of a discrete layer (126) to the corium layer (123). This may be bonded by a suitable compatible adhesive, or by the resin layer (123). This layer (126) is typically a woven fabric, preferably impregnated with a polyurethane or other resin layer. The fabric may be a woven fabric of synthetic fibres (with optional natural fibre content). The synthetic fibres may include: nylon, Kevlar®, Cordura®, Zylon®, Magellan M5®, ballistic fibres, and combinations thereof.

As an option, additional reinforcing material (125) may be positioned within the adhesive/resin layer (123) allowing composite type materials to be built up. In a specialised application the reinforcing material may be conductive, to provide electromagnetic shielding (for applications where the modified leather is used in a jacket), static discharge properties, or use as an antenna for connected devices.

### Example 4

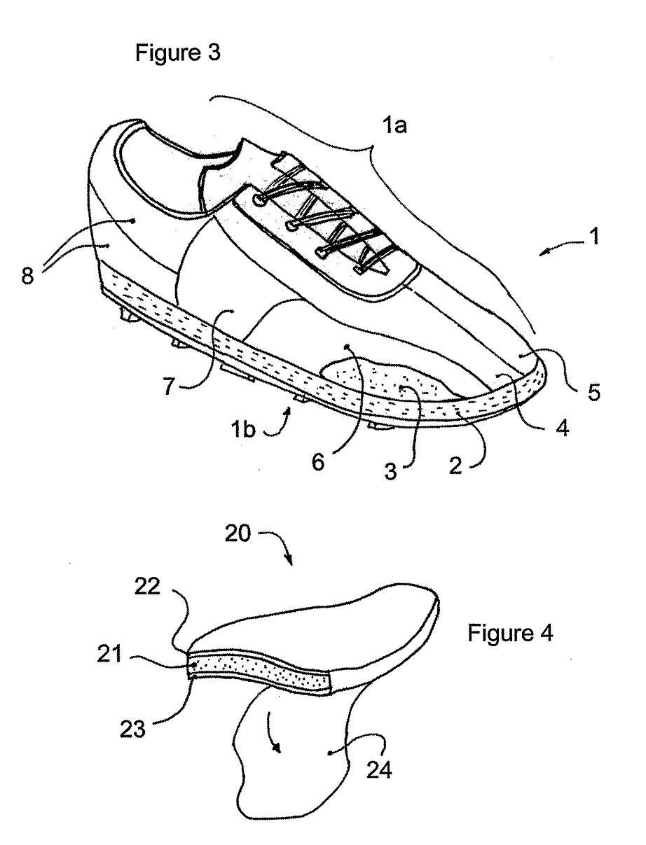

FIG. 3 illustrates a soccer boot (1). There is generally indicated an upper (1a) and a sole (1b). The sole may be of standard construction for the type of shoe or boot.

The upper comprises sections of different materials stitched together, though other methods of construction can be implemented. For simplicity, we shall refer to common stitched construction in this example.

Sections (2) and (3) may be formed (for this example) from a modified caprine leather such as described in Example 1. These sections may be further coated with a Poly-isobutylene (PIB) polymer, optionally co-polymerised with 0.01-8.0% isoprene. The RMM of the PIB is preferably within the inclusive range of 600-1500, and more preferably 850-1200.

Front sections (4), (5), and (6) may be formed from a modified caprine leather such as described in Example 2. These may also optionally be coated with a PIB polymer. Side section (7) may, for example, be a laminated caprine leather as per example 2, but wherein the fabric is a non-ballistic type fabric and includes an elastane type fibre, such as Lycra®

The rear portion (8) may be of various materials according to user choice, and may comprise leather derived from the backbone region of the animal. This may be a non-modified leather (as per examples 1 and 2), but a caprine leather which has had its grain face modified by texturising, whereby a durable design is cut into the surface of the leather, by various means such as laser etching, print and buff, etc. These leathers would most likely remain uncoated, and can offer enhanced grip characteristics. Panels of such leather may be positioned elsewhere on the upper.

It should be noted that this represents just one possible application of the present invention out of many. Not all sports shoes need be constructed in this way, nor include as many different aspects of the invention.

### Example 5

FIG. 4 illustrates a patch (20) according to the present invention shown partly in cross-section though the dimensions have been exaggerated. This is a modified leather, such as has been prepared according to the principles of Example (2)—for instance.

The underside (23) comprises an adhesive material overlaid with a removable protective backing (24).

In practice the patch can be trimmed to shape, if needed, and adhered to the outer surface of a shoe where required. As variations, adhesives able to adhere to damp or wet surfaces may be employed, allowing application to a damp shoe during a game. Also, pre-contoured patches may be available, which are contoured in 3-dimensions to fit over contoured regions of a shoe such as the tip of the toe portion.

Aspects of the present invention have been described by way of example only and it should be appreciated that modifications and additions may be made thereto without departing from the spirit or scope of the present invention as originally intended.

It should also be understood that the term “comprise” where used herein is not to be considered to be used in a limiting sense. Accordingly, ‘comprise’ does not represent nor define an exclusive set of items, but includes the possibility of other components and items being added to the list.

All references, including any patents or patent applications cited in this specification are hereby incorporated by reference. No admission is made that any reference constitutes prior art. The discussion of the references states what their authors assert, and the applicants reserve the right to challenge the accuracy and pertinence of the cited documents. It will be clearly understood that, although a number of prior art publications are referred to herein, this reference does not constitute an admission that any of these documents form part of the common general knowledge in the art, in New Zealand or in any other country.

1-63. (canceled)

64. A method for modifying caprine leather comprising the application of at least one bonded layer to the rear of the leather, in which a said layer exhibits a greater tensile strength, relative to the unprocessed caprine leather, in at least one direction.

65. A method as claimed in claim 64 in which the said layer exhibits a greater tensile strength, relative to the unprocessed caprine leather, in at least two non-parallel directions.

66. A method as claimed in claim 64 in which a said layer is either or both stretch resistant and cut resistant.

67. A method as claimed in claim 64 in which a said bonded layer includes a layer of a woven fabric.

68. A method as claimed in claim 67 in which the fabric comprises one or more fabrics from the group comprising: canvas, cordura, a ballistic fibre, or an aramid fibre fabric.

69. A method as claimed in claim 64 which includes a bonded layer comprising one or more reinforcing materials selected from the group comprising: ballistic fibres, aramid fibres, braided monofilaments, ceramic fibres, synthetic meshes, mats comprised of non-woven fibres.

70. A method as claimed in claim 64 which includes a bonded layer comprising a layer of a resin or thermoplastic material, and in which said resin or thermoplastic material impregnates into at least part of the fibre structure of the corium of the leather.

71. A method as claimed in claim 70 in which the resin or thermoplastic material includes a reinforcing material.

72. A method as claimed in claim 71 in which the reinforcing material comprises one or more materials from the group comprising: ballistic fibre filaments, aramid fibres, braided monofilaments, ceramic fibres, synthetic meshes, mats comprised of non-woven fibres, and woven fibres.

73. A method as claimed in claim 70 in which said resin or thermoplastic material acts also as a bonding agent in a said bonded layer.

74. A method as claimed in claim 70 in which the resin or thermoplastic material is selected from a group comprising: acrylics, urethanes, plastisols, butadienes, latex, rubber (natural and/or synthetic), polyester, neoprene (polychloroprene), silicones, and cyanoacrylates.

75. A method as claimed in claim 70 in which a urethane resin is used.

76. A method as claimed in claim 75 in which said urethane resin is loaded onto the leather at 20±10 g/sqft inclusive.

77. A method as claimed in claim 76 in which the modified caprine leather is reinforced with a ballistic material in a bonded layer.

78. A method as claimed in claim 64 in which the modified caprine leather has been fat-liquored.

79. A method as claimed in claim 78 in which the modified caprine leather has been fat-liquored to the extent that the stretchability of the leather layer has been increased.

80. A method as claimed in claim 64 in which the grain face of the leather has been flattened by mechanical processing.

81. A method as claimed in claim 80 in which the mechanical process is rotary ironing, optionally embossing with a finer grain print.

82. A method as claimed in claim 64 in which the leather has not been bated.

83. A method as claimed in claim 64 in which the leather has been subjected to a staking process.

84. A method as claimed in claim 64 in which the grain face of the modified caprine leather includes a coating.

85. A method as claimed in claim 84 in which the grain face coating comprises at least one of: a flex modifying coating; an abrasion resistant coating, a urethane or polyurethane resin, a water resistant coating.

86. A method as claimed in claim 64 in which the leather has been treated to exhibit water repellence or resistance.

87. A method as claimed in claim 64 in which at least part of the upper has been coated with a PIB polymer selected from the following group: polyisobutylene (also known as butyl rubber, 2-methyl-1-propene homopolymer, isobutylene polymer, polymerized 2-methylpropene, isobutylene resin, and has the molecular formula: [C₄H₈]ₙ), and polyisobutylene-isoprene copolymers.

88. A modified caprine leather for use in shoe or apparel manufacture resulting from a method as claimed in claim 64.

89. A modified caprine leather, as claimed in claim 88, in which the presence of said bonded layer or layers improves the tear strength of the leather to in excess of 30 N for a 0.8 mm thick leather, or proportionately relative thereto for greater thicknesses, using standard test method DIN 53329A.

90. A modified caprine leather, as claimed in claim 88, in which the bonded layer improves the tear strength of the leather to in excess of 40 N for a 0.8 mm thick leather, or proportionately relative thereto for greater thicknesses, using standard test method DIN 53329A.

91. A modified caprine leather, as claimed in claim 88, in which the tensile strength of the modified caprine leather is improved by at least 50% in at least one direction as opposed to the unmodified caprine leather.

92. A modified caprine leather, as claimed in claim 88, in which the tensile strength of the modified caprine leather is improved by at least 50% in at least two non-parallel directions as opposed to the unmodified caprine leather.

93. A modified caprine leather, as claimed in claim 88, in which the leather has been treated with hydrophobic fats within the fibre structure.

94. A modified caprine leather as claimed in claim 88 comprising a caprine leather to which a primer coating has been applied to the rear surface, there being also applied a resin or plastic bonding agent, and a fabric reinforcing layer.

95. A sports shoe in which at least part of the upper has been manufactured from a modified caprine leather, as claimed in claim 88.

96. A sports shoes as claimed in claim 95 in which at least part of the upper has been coated with A PIB polymer selected from the following group: polyisobutylene (also known as butyl rubber, 2-methyl-1-propene homopolymer, isobutylene polymer, polymerized 2-methylpropene, isobutylene resin, and has the molecular formula: [C₄H₈]ₙ), and polyisobutylene-isoprene copolymers.

97. A sports shoes as claimed in claim 95 in which sections of leather are joined by stitching which is protected by a layer limiting sweat or moisture migration.

98. A sports shoes as claimed in claim 95 in which the sports shoe is a soccer boot.

99. An adhesive patch for application to a sports shoe or boot, the patch comprising an area of modified caprine leather, as claimed in claim 88, with a self-adhesive backing on the non-grain face thereof.
